(19) United States
(12) Patent Application Publication
(10) Pub. No.: US 2020/0370640 A1
(43) Pub. Date: Nov. 26, 2020

(54) CONTROL METHOD FOR POWER TRANSMISSION DEVICE, AND CONTROL DEVICE FOR POWER TRANSMISSION DEVICE

(71) Applicant: NISSAN MOTOR CO., LTD., Yokohama-shi, Kanagawa (JP)

(72) Inventors: Tomoyuki NAKANO, Kanagawa (JP); Ryohey TOYOTA, Kanagawa (JP); Kouichi KOTSUJI, Numazu-shi, Shizuoka (JP)

(73) Assignee: NISSAN MOTOR CO., LTD., Yokohama-shi, Kanagawa (JP)

(21) Appl. No.: 16/958,234

(22) PCT Filed: Dec. 20, 2018
(86) PCT No.: PCT/JP2018/047111

§ 371 Date: Jun. 26, 2020

(30) Foreign Application Priority Data
Dec. 28, 2017 (JP) 2017-254764

(51) Int. Cl. F16H 61/00; F16H 61/662

(52) U.S. Cl. CPC F16H 61/0031; F16H 61/12; F16H 61/66272

(57) ABSTRACT

A control method for a power transmission device includes: performing a switching of a switching valve at a time when an idling stop condition is not satisfied or when a first idling stop condition is satisfied, the time corresponding to a time when a predetermined condition is satisfied; and performing a hydraulic pressure increase of increasing a PRI pressure or an SEC pressure compared to before the predetermined condition is satisfied when switching the switching valve.

### TECHNICAL FIELD

The present invention relates to a control method for a power transmission device and a control device for the power transmission device.

### BACKGROUND ART

JP2005-30495A discloses a belt continuously variable transmission in which an electric oil pump for shift is provided in an oil passage communicating between a primary pulley oil chamber and a secondary pulley oil chamber. The technology of JP2005-30495A employs a switching valve for using the electric oil pump for shift as a pump for a source pressure.

### SUMMARY OF INVENTION

It is conceivable to supply oil in an oil reservoir to the primary pulley oil chamber by using the electric oil pump for shift as the pump for the source pressure by the switching of the switching valve as described above.

However, when switching the switching valve, smaller hydraulic pressure is transmitted to the pulley oil chamber due to the switching of the switching valve compared to before switching the switching valve. Then, when a hydraulic pressure in the pulley oil chamber is decreased according to this and falls below the torque capacity guarantee pressure of a continuously variable transmission mechanism, slip may occur in the continuously variable transmission mechanism.

The present invention has been made in view of such problems, and an object of the present invention is to provide a control method for a power transmission device and a control device for the power transmission device in which oil in the oil reservoir can be supplied to the primary pulley oil chamber via the electric oil pump for shift by the switching of the switching valve and the occurrence of slip in the continuously variable transmission mechanism can be suppressed when switching the switching valve.

According to a certain aspect of the present invention, provided is a control method for a power transmission device including a continuously variable transmission mechanism configured to perform power transmission between a driving source and driving wheels, a first oil passage communicating between a primary pulley oil chamber and a secondary pulley oil chamber of the continuously variable transmission mechanism, an electric oil pump provided in the first oil passage, a second oil passage branching off from the first oil passage between the electric oil pump and the primary pulley oil chamber and communicating with an oil reservoir, a switching valve provided at a branch point of the first oil passage and the second oil passage, and a third oil passage branching off from the first oil passage between the electric oil pump and the secondary pulley oil chamber and reaching the switching valve. The switching valve is configured to switch between two positions of a first position at which at least the first oil passage is in a communication state and a second position at which the second oil passage and the first oil passage on a secondary pulley oil chamber side are in a communication state and the third oil passage and the first oil passage on a primary pulley oil chamber side are in a communication state. The control method includes performing a switching of the switching valve when a predetermined condition is satisfied, and performing, when switching the switching valve, a hydraulic pressure increase of increasing a hydraulic pressure of the primary pulley oil chamber or the secondary pulley oil chamber compared to before the predetermined condition is satisfied.

According to another aspect of the present invention, a control device for the power transmission device corresponding to the control method for the transmission device mentioned above is provided.

### BRIEF DESCRIPTION OF DRAWINGS

FIG. 1 is a schematic configuration diagram illustrating the main parts of a vehicle.

FIG. 2A is the first diagram of an explanatory diagram of the switching position of a switching valve.

FIG. 2B is the second diagram of the explanatory diagram of the switching position of the switching valve.

FIG. 3 is a flowchart illustrating a first example of control performed by a controller.

FIG. 4 is a diagram illustrating an example of a timing chart corresponding to the first example.

FIG. 5A is the first diagram illustrating the state of the main parts of a hydraulic circuit corresponding to the first example.

FIG. 5B is the second diagram illustrating the state of the main parts of the hydraulic circuit corresponding to the first example.

FIG. 5C is the third diagram illustrating the state of the main parts of the hydraulic circuit corresponding to the first example.

FIG. 6 is a flowchart illustrating a second example of control performed by the controller.

FIG. 7 is a diagram illustrating an example of a timing chart corresponding to the second example.

FIG. 8A is the first diagram illustrating the state of the main parts of a hydraulic circuit corresponding to the second example.

FIG. 8B is the second diagram illustrating the state of the main parts of the hydraulic circuit corresponding to the second example.

FIG. 8C is the third diagram illustrating the state of the main parts of the hydraulic circuit corresponding to the second example.

### DESCRIPTION OF EMBODIMENTS

Hereinafter, exemplary embodiments of the present invention will be explained with reference to the accompanying drawings.

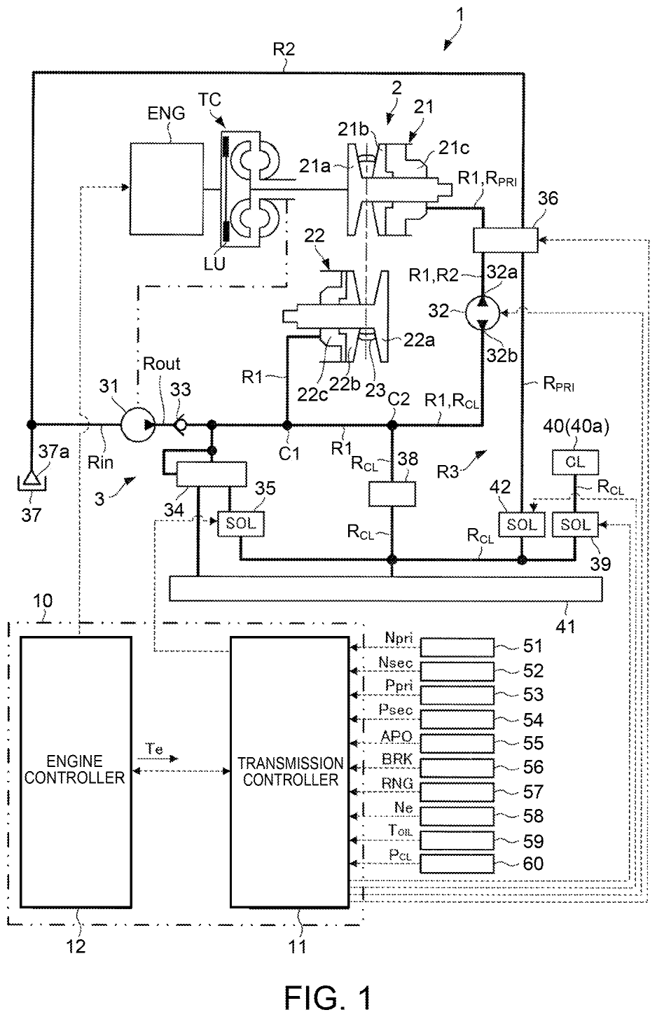

FIG. 1 is a schematic configuration diagram illustrating the main parts of a vehicle. A transmission 1 is a belt continuously variable transmission, and is mounted on the vehicle together with an engine ENG constituting the driving source of the vehicle. The rotation from the engine ENG is input to the transmission 1. The output rotation of the engine ENG is input to the transmission 1 via a torque converter TC etc. having a lock-up clutch LU. The transmission 1 outputs the input rotation at a rotation according to a speed ratio. The speed ratio is a value obtained by dividing the input rotation by the output rotation.

The transmission 1 includes a variator 2 and a hydraulic circuit 3.

The variator 2 is provided in a power transmission path connecting the engine ENG and driving wheels not illustrated, and performs power transmission between these. The variator 2 is a belt continuously variable transmission mechanism that includes a primary pulley 21, a secondary pulley 22, and a belt 23 wrapped around the primary pulley 21 and the secondary pulley 22.

The variator 2 changes the wrapping diameter of the belt 23 to perform the shift by changing the groove widths of the primary pulley 21 and the secondary pulley 22. Hereinafter, “primary” is referred to as PRI and “secondary” is referred to as SEC.

The PRI pulley 21 includes a fixed pulley 21a, a movable pulley 21b, and a PRI pulley oil chamber 21c. In the PRI pulley 21, oil is supplied to the PRI pulley oil chamber 21c. When the movable pulley 21b moves due to the oil in the PRI pulley oil chamber 21c, the groove width of the PRI pulley 21 is changed.

The SEC pulley 22 includes a fixed pulley 22a, a movable pulley 22b, and an SEC pulley oil chamber 22c. In the SEC pulley 22, oil is supplied to the SEC pulley oil chamber 22c. When the movable pulley 22b moves due to the oil in the SEC pulley oil chamber 22c, the groove width of the SEC pulley 22 is changed.

The belt 23 is wrapped around a V-shaped sheave surface formed by the fixed pulley 21a and the movable pulley 21b of the PRI pulley 21 and a V-shaped sheave surface formed by the fixed pulley 22a and the movable pulley 22b of the SEC pulley 22. The belt 23 is held by a belt clamping force generated by an SEC pressure Psec. The SEC pressure Psec is the pulley pressure of the SEC pulley 22, and specifically is the hydraulic pressure of the SEC pulley oil chamber 22c.

The hydraulic circuit 3 includes, in addition to the PRI pulley oil chamber 21c and the SEC pulley oil chamber 22c, a mechanical oil pump 31, an electric oil pump 32, a check valve 33, a line pressure adjusting valve 34, a line pressure solenoid 35, a switching valve 36, an oil reservoir 37, a pilot valve 38, a clutch pressure solenoid 39, a clutch 40, a T/C hydraulic system 41, and a PRI pressure solenoid 42. These configurations constitute the hydraulic circuit 3 together with oil passages as described below.

The PRI pulley oil chamber 21c and the SEC pulley oil chamber 22c are communicated by a first oil passage R1. The mechanical oil pump 31 is connected to the first oil passage R1 via a discharge-side oil passage Rout of the mechanical oil pump 31. The mechanical oil pump 31 is a mechanical oil pump driven by the power of the engine ENG, and is coupled to the impeller of the torque converter TC via a power transmission member as schematically illustrating the coupled state with a two-point dashed line.

The check valve 33 is provided in the discharge-side oil passage Rout. The check valve 33 prevents the flow of oil toward the mechanical oil pump 31 and allows the flow of oil in the opposite direction. The line pressure adjusting valve 34 is connected to the discharge-side oil passage Rout at a portion downstream from the check valve 33.

The line pressure adjusting valve 34 adjusts a pressure of oil supplied from the mechanical oil pump 31 to a line pressure PL. The line pressure adjusting valve 34 operates in accordance with a solenoid pressure generated by the line pressure solenoid 35. In the present embodiment, the line pressure PL is supplied to the SEC pulley oil chamber 22c as the SEC pressure Psec. The line pressure PL constitutes the source pressure of oil used as hydraulic oil in a power transmission device according to the present embodiment configured as described below.

The electric oil pump 32 and the switching valve 36 are provided in the first oil passage R1. The electric oil pump 32 is provided in the first oil passage R1 at a portion closer to the PRI pulley oil chamber 21c than a first point C1 that is a point to which the discharge-side oil passage Rout is connected. The electric oil pump 32 can be rotatable in forward and reverse directions. Specifically, the forward direction is a direction of supplying oil to the PRI pulley oil chamber 21c side and the reverse direction is a direction of supplying oil to the SEC pulley oil chamber 22c side.

The switching valve 36 is provided in the first oil passage R1 between the electric oil pump 32 and the PRI pulley oil chamber 21c. The switching valve 36 includes a first position P1 and a second position P2 as switching positions, and is configured to be able to switch between the first position P1 and the second position P2. The switching positions of the switching valve 36 will be described below.

The electric oil pump 32 communicates with the oil reservoir 37 through a second oil passage R2. Specifically, the second oil passage R2 is connected to a strainer 37a in the oil reservoir 37. The second oil passage R2 includes an oil passage to communicate between the oil reservoir 37 and the switching valve 36 and a portion of the first oil passage R1 between the switching valve 36 and the electric oil pump 32. The former oil passage is an oil passage not including other oil passages connected to the switching valve 36. The switching valve 36 is provided to connect these oil passages, and consequently is further provided in the second oil passage R2. Such the switching valve 36 can be grasped as a switching valve provided at a branch point of the first oil passage R1 and the second oil passage R2.

Specifically, the second oil passage R2 is connected to an oil inlet/outlet port 32a of the electric oil pump 32 on the PRI pulley oil chamber 21c side. The portion of the first oil passage R1 between the switching valve 36 and the electric oil pump 32 also serves as a part of the second oil passage R2. The mechanical oil pump 31 is also connected via a suction-side oil passage Rin to a portion of the second oil passage R2 closer to the oil reservoir 37 than the switching valve 36.

Such the second oil passage R2 can be grasped as an oil passage branching off from the first oil passage R1 between the electric oil pump 32 and the PRI pulley oil chamber 21c and communicating with the oil reservoir 37.

The oil reservoir 37 is an oil reservoir that stores oil to be supplied by the mechanical oil pump 31 and the electric oil pump 32, and oil is sucked from the oil reservoir 37 via the strainer 37a. The oil reservoir 37 may be constituted by a plurality of oil reservoirs.

The electric oil pump 32 communicates with the clutch 40, specifically, a clutch oil chamber 40a of the clutch 40 via a clutch oil passage R_{CL}. The clutch oil passage R_{CL} includes a portion of the first oil passage R1 between the electric oil pump 32 and a second point C2. The second point C2 is a point in the first oil passage R1 between the electric oil pump 32 and the first point C1. The clutch oil passage R_{CL} further includes an oil passage communicating between the second point C2 and the clutch 40.

Specifically, the clutch oil passage R_{CL} is connected to an oil inlet/outlet port 32b of the electric oil pump 32 on the SEC pulley oil chamber 22c side. The portion of the first oil passage R1 between the electric oil pump 32 and the second point C2 also serves as a part of the clutch oil passage R_{CL}. The clutch oil passage R_{CL} is an oil passage not including the second oil passage R2.

The clutch 40 is engaged by supplying oil to the clutch oil chamber 40a and is disengaged by draining oil from the clutch oil chamber 40a. The clutch 40 performs the power transmission between the engine ENG and the driving wheels together with the variator 2. The clutch 40 performs connection and disconnection of the power transmission path connecting the engine ENG and the driving wheels. The clutch 40 constitutes hydraulic device other than the variator 2.

The pilot valve 38 is provided in the clutch oil passage R_{CL} at a portion branching off from the first oil passage R1. Moreover, the clutch pressure solenoid 39 is provided in the clutch oil passage R_{CL} at a portion between the pilot valve 38 and the clutch 40. The pilot valve 38 reduces the pressure of oil supplied from the first oil passage R1. The clutch pressure solenoid 39 adjusts a hydraulic pressure supplied to the clutch 40, namely, a hydraulic pressure P_{CL} in the clutch oil chamber 40a.

Further, a PRI oil passage Rpm branches off from the clutch oil passage R_{CL} and communicates with the PRI pulley oil chamber 21c. The PRI oil passage R_{PRI} includes an oil passage communicating between the clutch oil passage R_{CL} and the switching valve 36 and a portion of the first oil passage R1 between the switching valve 36 and the PRI pulley oil chamber 21c. The former oil passage is an oil passage not including other oil passages connected to the switching valve 36. The switching valve 36 is provided to connect these oil passages, and consequently is further provided in the PRI oil passage R_{PRI}.

Specifically, the PRI oil passage R_{PRI} branches off from the clutch oil passage R_{CL} between the pilot valve 38 and the clutch pressure solenoid 39. Moreover, the PRI pressure solenoid 42 is provided in the PRI oil passage R_{PRI}. The PRI pressure solenoid 42 is a pressure control valve that adjusts a pressure of oil supplied to the PRI pulley oil chamber 21c, and is provided in the PRI oil passage R_{PRI} between the switching valve 36 and the clutch oil passage R_{CL}. The portion of the first oil passage R1 between the PRI pulley oil chamber 21c and the switching valve 36 also serves as a part of the PRI oil passage R_{PRI}.

Such the PRI oil passage R_{PRI} can be grasped as a third oil passage R3 branching off from the first oil passage R1 between the electric oil pump 32 and the SEC pulley oil chamber 22c and reaching the switching valve 36, together with a part of the clutch oil passage R_{CL} (specifically, the clutch oil passage R_{CL} between the second point C2 and the point from which the PRI oil passage R_{PRI} branches).

In addition, oil passages are provided in the hydraulic circuit 3. The oil passages branch off from the clutch oil passage R_{CL} at a portion between the pilot valve 38 and the clutch pressure solenoid 39 and are respectively connected to the line pressure solenoid 35 and the T/C hydraulic system 41.

The line pressure solenoid 35 generates a solenoid pressure according to a command value of the line pressure PL and supplies the solenoid pressure to the line pressure adjusting valve 34. The T/C hydraulic system 41 is a hydraulic system for the torque converter TC that includes the lock-up clutch LU, and oil drained from the line pressure adjusting valve 34 is also supplied to the T/C hydraulic system 41.

In the hydraulic circuit 3 thus configured, the mechanical oil pump 31 supplies the SEC pressure Psec to the SEC pulley oil chamber 22c, and the electric oil pump 32 controls the supply and discharge of the oil to and from the PRI pulley oil chamber 21c. The mechanical oil pump 31 is used for holding the belt 23, and the electric oil pump 32 is used for the shift.

That is, as a shift principle, the shift is performed by moving oil from one to the other of the PRI pulley oil chamber 21c and the SEC pulley oil chamber 22c by the electric oil pump 32.

A controller 10 is further provided in the vehicle. The controller 10 is configured to include a transmission controller 11 and an engine controller 12.

Signals from a rotation sensor 51 for detecting the input-side rotation speed of the variator 2, a rotation sensor 52 for detecting the output-side rotation speed of the variator 2, a pressure sensor 53 for detecting the PRI pressure Ppri, and a pressure sensor 54 for detecting the SEC pressure Psec are input to the transmission controller 11. The rotation sensor 51 specifically detects a rotation speed Npri of the PRI pulley 21. The rotation sensor 52 specifically detects a rotation speed Nsec of the SEC pulley 22. The PRI pressure Ppri is the pulley pressure of the PRI pulley 21, and specifically is the hydraulic pressure of the PRI pulley oil chamber 21c. The transmission controller 11 can detect a vehicle speed VSP based on the input from the rotation sensor 52.

Furthermore, signals from an accelerator pedal opening sensor 55, a brake sensor 56, a selected range detection switch 57, an engine rotation sensor 58, an oil temperature sensor 59, and a hydraulic sensor 60 are input to the transmission controller 11.

The accelerator pedal opening sensor 55 detects an accelerator pedal opening APO indicating the operation amount of an accelerator pedal. The brake sensor 56 detects a brake pedal depression force BRK. The selected range detection switch 57 detects a range RNG selected by a shift lever that is a selector. The engine rotation sensor 58 detects a rotation speed Ne of the engine ENG. The oil temperature sensor 59 detects an oil temperature T_{OIL} of the transmission 1. The oil temperature T_{OIL} is the temperature of oil used as hydraulic oil in the power transmission device according to the present embodiment. The hydraulic sensor 60 detects the hydraulic pressure P_{CL}.

The transmission controller 11 is connected to the engine controller 12 so as to be communicable with each other. Herein, engine torque information Te is input to the transmission controller 11 from the engine controller 12. The signals from the accelerator pedal opening sensor 55 and the engine rotation sensor 58 may be input to the transmission controller 11 via the engine controller 12, for example.

The transmission controller 11 generates a control signal including a shift control signal based on the input signals, and outputs the generated control signal to the hydraulic circuit 3. In the hydraulic circuit 3, the electric oil pump 32, the line pressure solenoid 35, the switching valve 36, the clutch pressure solenoid 39, the PRI pressure solenoid 42, and the like are controlled based on the control signal from the transmission controller 11. As a result, the speed ratio of the variator 2 is controlled to a speed ratio according to the shift control signal, that is, a target speed ratio, for example.

In the present embodiment, the controller 10 including the transmission controller 11 and the engine controller 12 constitutes the power transmission device together with the transmission 1. The power transmission device has the first mode using the electric oil pump 32 for the shift in which the switching position of the switching valve 36 is set to the first position P1 and the second mode using the electric oil pump 32 for the source pressure in which the switching position of the switching valve 36 is set to the second position P2.

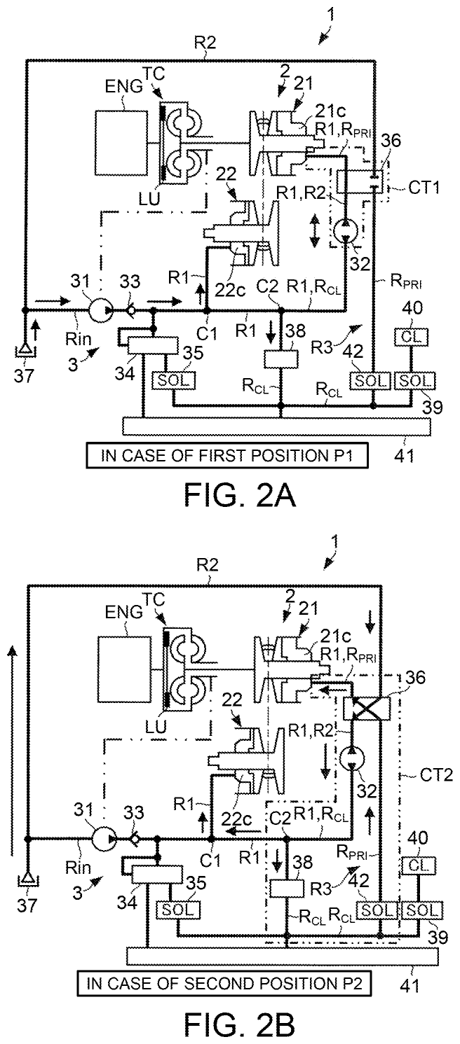

FIGS. 2A and 2B are explanatory diagrams of the switching positions of the switching valve 36. FIG. 2A illustrates a case where the switching position, i.e., a valve position is the first position P1 and FIG. 2B illustrates a case where the switching position is the second position P2. In other words, FIGS. 2A and 2B are explanatory diagrams for the first mode and the second mode.

The first position P1 is a switching position at which the first oil passage R1 is set to the communication state and the second oil passage R2 is set to the blocked state. The PRI oil passage R_{PRI} is further set to the blocked state at the first position P1. As a result, in the case of the first position P1, the mechanical oil pump 31 supplies the oil in the oil reservoir 37 to the SEC pulley oil chamber 22c and the clutch 40, and the electric oil pump 32 controls the supply and discharge of the oil to and from the PRI pulley oil chamber 21c.

The second position P2 is a switching position at which the first oil passage R1 is set to the blocked state and the second oil passage R2 is set to the communication state. The PRI oil passage R_{PRI} is further set to the communication state at the second position P2. As a result, in the case of the second position P2, the electric oil pump 32 communicates with the clutch 40 and the PRI pulley oil chamber 21c, and supplies the oil in the oil reservoir 37 to the clutch 40 and the PRI pulley oil chamber 21c.

Furthermore, in the case of the second position P2, the oil in the clutch oil passage R_{CL} can be adjusted in pressure by the PRI pressure solenoid 42 and supplied to the PRI pulley oil chamber 21c. Therefore, even if the first oil passage R1 is blocked by the switching valve 36, the variator 2 can be shifted.

The first position P1 and the second position P2 will be further explained. A first PRI circuit CT1 is formed at the first position P1. The first PRI circuit CT1 is a first supply/discharge circuit formed at the first position P1 as a circuit supplying/discharging oil to/from the PRI pulley oil chamber 21c. Specifically, the first PRI circuit CT1 is configured to include the electric oil pump 32, the switching valve 36, and the oil passages provided between the electric oil pump 32 and the PRI pulley oil chamber 21c.

The hydraulic pressure of the first PRI circuit CT1 is a PRI-side pressure Pc1 controlled by the electric oil pump 32. The PRI-side pressure Pc1 is a hydraulic pressure on the PRI pulley oil chamber 21c side, that is, the oil inlet/outlet port 32a side of the electric oil pump 32. Specifically, the PRI-side pressure Pc1 is indicated by the hydraulic pressure of a portion of the first PRI circuit CT1 between the electric oil pump 32 and the switching valve 36 through the formed period and blocked period of the first PRI circuit CT1.

A second PRI circuit CT2 is formed at the second position P2. The second PRI circuit CT2 is a second supply/discharge circuit formed at the second position P2 as a circuit supplying/discharging oil to/from the PRI pulley oil chamber 21c. Specifically, the second PRI circuit CT2 is configured to include the electric oil pump 32, the pilot valve 38, the PRI pressure solenoid 42, the switching valve 36, and the oil passages provided between the electric oil pump 32 and the PRI pulley oil chamber 21c.

The hydraulic pressure of the second PRI circuit CT2 is a SOL pressure Pc2 controlled by the PRI pressure solenoid 42. The SOL pressure Pc2 is the hydraulic pressure on the PRI pulley oil chamber 21c side, that is, the downstream side of the PRI pressure solenoid 42. Specifically, the SOL pressure Pc2 is indicated by the hydraulic pressure in the second PRI circuit CT2 at a portion between the PRI pressure solenoid 42 and the switching valve 36 through the formed period and blocked period of the second PRI circuit CT2.

Such the switching valve 36 can be grasped as a switching valve switching between two positions of the first position P1 at which at least the first oil passage R1 is set to the communication state and the second position P2 at which the second oil passage R2 and the first oil passage R1 on the SEC pulley oil chamber 22c side are set to the communication state and the third oil passage R3 and the first oil passage R1 on the PRI pulley oil chamber 21c side are set to the communication state.

In the present embodiment, as previously described by using FIG. 2B, the oil in the oil reservoir 37 can be supplied to the PRI pulley oil chamber 21c via the electric oil pump 32 by the switching of the switching valve 36.

However, when switching the switching valve 36, smaller hydraulic pressure is transmitted to the pulley oil chamber compared to before switching the switching valve 36. The pulley oil chamber is a generic name of the PRI pulley oil chamber 21c and the SEC pulley oil chamber 22c, and means at least one oil chamber of the PRI pulley oil chamber 21c and the SEC pulley oil chamber 22c.

When switching the switching valve 36, the position of the switching valve 36 is specifically switched between the first position P1 and the second position P2. Then, when switching the switching valve 36, smaller hydraulic pressure is transmitted to the pulley oil chamber due to the switching of the switching valve 36 compared to before switching the switching valve 36. As a result, when a hydraulic pressure in the pulley oil chamber is decreased according to this and falls below a torque capacity guarantee pressure PS of the variator 2, there is a concern that the slip may occur in the variator 2.

In light of these circumstances, the controller 10 performs the control described as follows in the present embodiment.

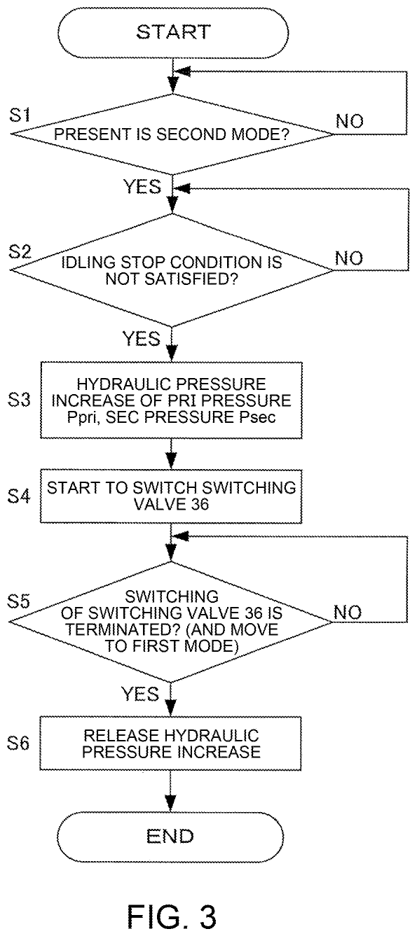

FIG. 3 is a flowchart illustrating a first example of control performed by the controller 10. The first example illustrates an example of control at the time of transition from the second mode to the first mode. The controller 10 is configured as a control device for the power transmission device that includes a first control unit and a second control unit by being configured to execute the processings of the present flowchart. The same applies to the second example to be described later.

In Step S1, the controller 10 determines whether the present mode is the second mode. For example, the second mode is applied at the idling stop of the engine ENG. The idling stop is a driving-source automatic stop control, and is executed when an idling stop condition to be described later is satisfied. Accordingly, the controller 10 can determine whether the present mode is the second mode by determining whether the idling stop condition is being satisfied, for example.

The idling stop condition is a condition including that the vehicle speed VSP is zero, that the brake pedal is depressed, and that the accelerator pedal is not depressed. The idling stop condition is satisfied when all conditions included in the idling stop condition are satisfied. The idling stop condition is not satisfied when any of conditions included in the idling stop condition is not satisfied. When the idling stop condition is not satisfied, the engine ENG is started. If a negative determination is made in Step S1, the processings return to Step S1. If a positive determination is made in Step S1, the processings proceed to Step S2.

In Step S2, the controller 10 determines whether the idling stop condition is not satisfied. In Step S2, it is determined whether the mode is switched to the first mode, accordingly whether the switching valve 36 is switched to the first position P1. If a negative determination is made in Step S2, the processings return to Step S2. If a positive determination is made in Step S2, the processings proceed to Step S3.

In Step S3, the controller 10 performs the hydraulic pressure increases of increasing the PRI pressure Ppri and further the SEC pressure Psec. Such the hydraulic pressure increases can be performed by setting an indication pressure that is the indicated value of the PRI pressure Ppri and an indication pressure of the SEC pressure Psec.

In Step S3, specifically, the controller 10 increases the hydraulic pressure of a pulley oil chamber of which the hydraulic pressure decreases in accordance with the switching of the switching valve 36, among the PRI pulley oil chamber 21c and the SEC pulley oil chamber 22c, by the hydraulic pressure increase of the PRI pressure Ppri by an amount equal to the amount of the hydraulic pressure decreased in this pulley oil chamber. The decreased amount of the hydraulic pressure is a decreased amount of hydraulic pressure when the hydraulic pressure increase of the PRI pressure Ppri is not performed.

When moving to the first mode, the pulley oil chamber is specifically the PRI pulley oil chamber 21c. Therefore, in Step S3, the hydraulic pressure of the PRI pulley oil chamber 21c is increased by the increase in the hydraulic pressure of the PRI pressure Ppri. In Step S3, the controller 10 may increase the hydraulic pressure of the PRI pulley oil chamber 21c by an amount equal to or larger than the decreased amount of the hydraulic pressure.

Meanwhile, by simply increasing the PRI pressure Ppri, a high shift occurs in which the speed ratio is changed to a high side, that is, a direction in which the speed ratio becomes small. For this reason, in Step S3, the controller 10 further prevents the high shift of the speed ratio by the hydraulic pressure increase of the SEC pressure Psec.

In Step S4, the controller 10 starts to switch the switching valve 36. That is, the switching of the switching valve 36 is performed when the idling stop condition is not satisfied. The specific switching start timing of the switching valve 36 is, for example, a timing after the rotation speed Ne becomes an idling rotation speed.

In Step S5, the controller 10 determines whether the switching of the switching valve 36 is terminated. Such determination can be performed based on the switching position of the switching valve 36, for example.

In Step S5, the controller 10 determines specifically whether the switching of the switching valve 36 is terminated and the present mode is moved to the first mode. The PRI pressure Ppri is not originally changed in accordance with the stop of the idling stop. Meanwhile, if the increase in the hydraulic pressure of the PRI pressure Ppri performed in Step S3 is not released, the PRI pressure Ppri becomes higher than before the idling stop condition is not satisfied when the present mode is moved to the first mode.

For this reason, in further determining the transition to the first mode, the controller 10 specifically determines whether the PRI pressure Ppri decreased according to the switching of the switching valve 36 becomes higher than before the idling stop condition is not satisfied. Such determination can be performed based on the output of the pressure sensor 53, for example. If a negative determination is made in Step S5, the processings return to Step S5. If a positive determination is made in Step S5, the processings proceed to Step S6.

In Step S6, the controller 10 releases the hydraulic pressure increases performed in Step S3. The release of the hydraulic pressure increases can be performed by decreasing the indication pressure of the PRI pressure Ppri, further the indication pressure of the SEC pressure Psec, by the increased amounts of the indication pressures. After Step S6, the processings of the present flowchart are once terminated.

When the hydraulic pressure increase of the PRI pressure Ppri is released after determining the transition to the first mode, the PRI pressure Ppri becomes higher than that in magnitude before the idling stop condition is not satisfied until the hydraulic pressure of the increased amount is actually decreased, and thus the transition to the first mode is delayed that much.

For this reason, the controller 10 may release the hydraulic pressure increases of the PRI pressure Ppri and further the SEC pressure Psec after the switching of the switching valve 36 is terminated and before the present mode moves to the first mode. For the sake of this, the hydraulic pressure increases can be released as illustrated in a timing chart described as follows, for example.

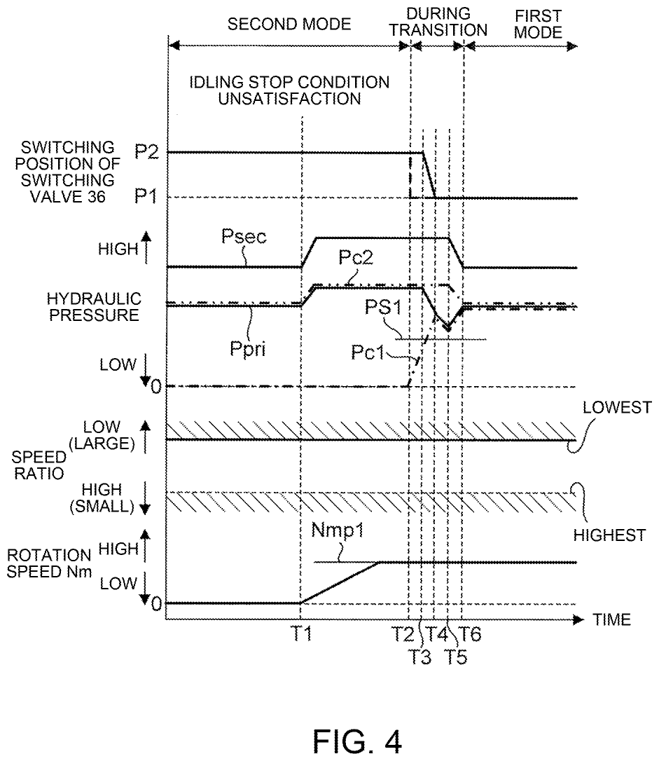

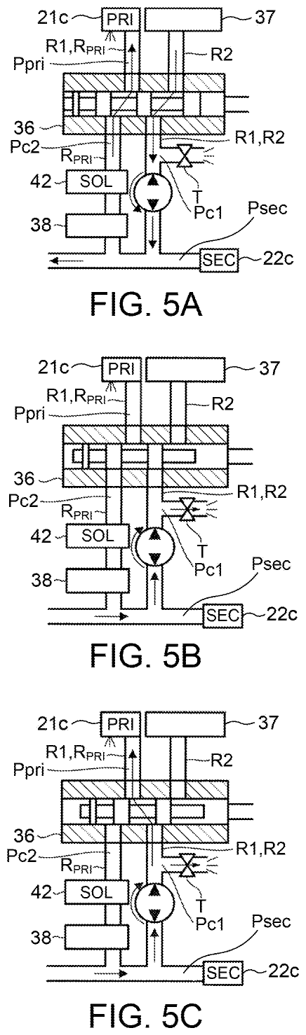

FIG. 4 is a diagram illustrating an example of a timing chart corresponding to the first example. FIGS. 5A, 5B, and 5C are diagrams illustrating the states of the main parts of the hydraulic circuit 3 corresponding to the first example. FIG. 4 illustrates a case where the hydraulic pressure increase is released after the switching of the switching valve 36 is terminated and before the present mode moves to the first mode. A rotation speed Nmp indicates the rotation speed of the mechanical oil pump 31. A torque capacity guarantee pressure PS1 indicates the torque capacity guarantee pressure PS for the PRI pulley 21.

The second mode is from a time T1 to a time T2. Therefore, as illustrated in FIG. 5A, during this period, the electric oil pump 32 is used for the source pressure and the PRI pressure Ppri is constituted by the SOL pressure Pc2. As illustrated in FIG. 5A, the first oil passage R1 between the electric oil pump 32 and the switching valve 36 is specifically branched and connected to a throttle T. The throttle T communicates between the oil reservoir 37 and the first oil passage R1 between the electric oil pump 32 and the switching valve 36. A reason for providing the throttle T will be described below.

The idling stop condition is not satisfied at the time T1. Therefore, the increase in the hydraulic pressure of the PRI pressure Ppri and further the SEC pressure Psec is performed, and thus the PRI pressure Ppri and further the SEC pressure Psec actually start to increase. The hydraulic pressure increase of the PRI pressure Ppri is performed by increasing the indication pressure of the SOL pressure Pc2.

At the time T1, the starting of the engine ENG is started and thus the rotation speed Nmp also starts to increase. That is, the rotation speed Nmp is raised by using the mechanical oil pump 31 as a hydraulic source. The rotation speed Nmp becomes a rotation speed Nmp1 according to an idling rotation speed after the PRI pressure Ppri and further the SEC pressure Psec become the pressures in magnitude according to the indication pressures.

At the time T2, the rotation speed Nmp is the rotation speed Nmp1, and the switching of the switching valve 36 is started by issuing a switching command for the switching valve 36 to the first position P1 as indicated by a dashed line. As a result, the present mode moves to a mode during the transition from the second mode. While the communication states of the oil passages in the switching valve 36 are not changed, the actual position of the switching valve 36 is the second position P2 without change. At the time T2, the rotation direction of the electric oil pump 32 is also switched to a forward direction. As a result, the PRI-side pressure Pc1 starts to increase.

An oil passage communicated by the switching valve 36 at the second position P2 is blocked at a time T3. As a result, the actual position of the switching valve 36 is not the second position P2 but is an intermediate position between the first position P1 and the second position P2. An oil passage communicated by the switching valve 36 at the first position P1 is also blocked at the intermediate position. In FIG. 4, the intermediate position is illustrated by the degree of progress of the switching between the first position P1 and the second position P2. FIG. 5B illustrates a state when the actual position of the switching valve 36 is the intermediate position.

At the time T3, the oil passage communicated by the switching valve 36 at the second position P2 is blocked, and consequently the SOL pressure Pc2 is not supplied to the PRI pulley oil chamber 21c. For this reason, the PRI pressure Ppri starts to decrease from the time T3.

The actual position of the switching valve 36 becomes the first position P1 at a timing T4. As a result, the PRI pressure Ppri is constituted by the PRI-side pressure Pc1. FIG. 5C illustrates a state when the actual position of the switching valve 36 is the first position P1.

Even after the PRI pressure Ppri is constituted by the PRI-side pressure Pc1, the decrease in the PRI pressure Ppri is continued. This is for the following reason.

That is, at the times T3 and T4, the PRI-side pressure Pc1 is increased to become the PRI pressure Ppri before the idling stop condition is not satisfied at the time T1. In this case, as illustrated in FIG. 5B, the PRI-side pressure Pc1 is increased in the first oil passage R1 between the electric oil pump 32 and the switching valve 36 having a smaller volume than the PRI pulley oil chamber 21c.

Meanwhile, the PRI pressure Ppri is in a decreased state at the time T4. Then, at the time T4, depending on the PRI-side pressure Pc1 increased as described above, the decrease in the PRI pressure Ppri cannot be stopped and conversely the PRI-side pressure Pc1 is decreased, and consequently the decrease in the PRI pressure Ppri is continued.

Therefore, during the transition from the second mode to the first mode, the PRI pressure Ppri is decreased even after the switching of the switching valve 36 is completed in accordance with the switching of the switching valve 36 from the second position P2 to the first position P1.

When there is the decrease in the PRI pressure Ppri according to the switching of the switching valve 36, the PRI pressure Ppri cannot be faithfully changed in accordance with the indication pressure and thus may fall below the torque capacity guarantee pressure PS1.

In this regard, however, in this example, the hydraulic pressure increase of the PRI pressure Ppri is performed at the time T1. The PRI pressure Ppri is previously increased at the time T1 by the decreased amount of the hydraulic pressure of the PRI pressure Ppri that decreases in accordance with the switching of the switching valve 36.

Accordingly, even if the PRI pressure Ppri decreases in accordance with the switching of the switching valve 36 from the time T3, the influence is offset by the hydraulic pressure increase of the PRI pressure Ppri at the time T1. Therefore, the PRI pressure Ppri does not fall below the torque capacity guarantee pressure PS1.

As a result, before the PRI pressure Ppri falls below the torque capacity guarantee pressure PS1, the PRI pressure Ppri starts to increase at a time T5. In this example, the release of the hydraulic pressure increases of the PRI pressure Ppri and further the SEC pressure Psec is also performed near the time T5, and according to this, the SOL pressure Pc2 and further the SEC pressure Psec are decreased. As a result, at a time T6, the PRI pressure Ppri becomes higher than before the idling stop condition is not satisfied, and the present mode moves to the first mode.

The release of the hydraulic pressure increase of the PRI pressure Ppri as illustrated in this example can be performed as described below. That is, when the switching valve 36 is switched from the second position P2 to the first position P1 as the switching of the switching valve 36, the PRI pressure Ppri is constituted by the PRI-side pressure Pc1 after the switching of the switching valve 36. Then, the PRI pressure Ppri such as this one can be estimated based on the current value of the electric oil pump 32 and the actual hydraulic pressure of the SEC pressure Psec. Moreover, according to a difference between the estimated value such as this one and the indicated value of the PRI pressure Ppri, it is possible to grasp a timing at which the PRI pressure Ppri does not fall below the torque capacity guarantee pressure PS1 even if the hydraulic pressure increase of the PRI pressure Ppri is released.

Therefore, in this case, the hydraulic pressure increase of the PRI pressure Ppri can be released when the difference between the estimated value of the PRI pressure Ppri estimated as described above and the indicated value of the PRI pressure Ppri falls within a predetermined value. This predetermined value can be previously set as a value to define a timing at which the PRI pressure Ppri does not fall below the torque capacity guarantee pressure PS1 even if the hydraulic pressure increase of the PRI pressure Ppri is released.

The reason for providing the throttle T is as follows. Herein, in the first mode, when the indication pressure of the PRI pressure Ppri is the same as the indication pressure of the SEC pressure Psec, it is conceivable to stop the electric oil pump 32 in a state where the PRI pressure Ppri and the SEC pressure Psec become the same indication pressure.

However, in the electric oil pump 32 in the stopped state, a small amount of oil leaks out from gaps such as seals in the PRI pulley oil chamber 21c and the SEC pulley oil chamber 22c, and consequently the PRI pressure Ppri and the SEC pressure Psec may be changed to change the speed ratio. Meanwhile, in the electric oil pump 32, it is difficult to deal with the change in the PRI pressure Ppri and the SEC pressure Psec such as this one in the light of its control resolution.

For this reason, the throttle T is provided in order that it makes the electric oil pump 32 generate the flow rate of oil within a controllable range to activate the electric oil pump 32 within the controllable range by letting oil escape in the light of the control resolution of the electric oil pump 32.

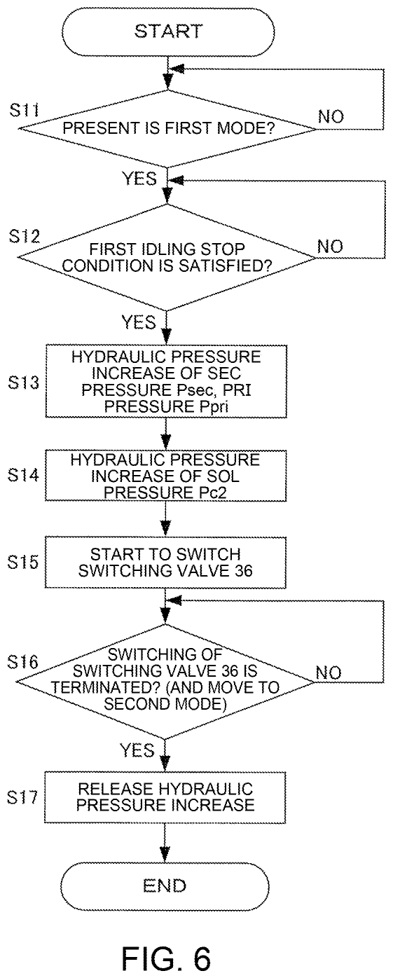

FIG. 6 is a flowchart illustrating the second example of control performed by the controller 10. The second example illustrates an example of control at the time of transition from the first mode to the second mode.

In Step S11, the controller 10 determines whether the present mode is the first mode. The first mode is applied to a case where the idling stop is not performed, for example. For this reason, the controller 10 can determine whether the present mode is the first mode by determining whether the idling stop condition is not satisfied, for example. If a negative determination is made in Step S11, the processings return to Step S11. If a positive determination is made in Step S11, the processings proceed to Step S12.

In Step S12, the controller 10 determines whether a first idling stop condition is satisfied. The first idling stop condition is the same as the idling stop condition described above and is the execution condition for a driving-source automatic stop control, but specifically is a preparation condition or a basic condition for execution.

That is, when moving to the second mode, the engine ENG is not promptly stopped even if the idling stop condition described above is satisfied, and the engine ENG is stopped when a second idling stop condition to be described later is satisfied. Therefore, in this case, the first idling stop condition and the second idling stop condition totally constitute one idling stop condition.

In other words, in Step S12, it is determined whether the mode is switched to the second mode and accordingly whether the switching valve 36 is switched to the second position P2. In the present embodiment, when the first idling stop condition is satisfied, the control of the electric oil pump 32 is switched to the hydraulic control according to the indication pressure from the shift control according to the target speed ratio. Therefore, in Step S12, in other words, it is determined whether the control of the electric oil pump 32 is switched to the hydraulic control from the shift control.

In the hydraulic control, the electric oil pump 32 is controlled in accordance with the indication pressure of the PRI pressure Ppri. The PRI pressure Ppri before switching to the hydraulic control such as just before switching to the hydraulic control, namely, before the first idling stop condition is satisfied is used as the indication pressure. If a negative determination is made in Step S12, the processings return to Step S12. If a positive determination is made in Step S12, the processings proceed to Step S13.

In Step S13, the controller 10 performs the hydraulic pressure increases of increasing the SEC pressure Psec and further the PRI pressure Ppri. At the time of the transition from the first mode to the second mode, by the hydraulic pressure increases of the SEC pressure Psec and further the PRI pressure Ppri, the controller 10 increases the hydraulic pressure of a pulley oil chamber of which the hydraulic pressure decreases in accordance with the switching of the switching valve 36 by an amount equal to the amount of the hydraulic pressure decreased in this pulley oil chamber. As described later, this is because the decrease in the SEC pressure Psec and further the PRI pressure Ppri occurs. When moving to the second mode, the pulley oil chamber is specifically the SEC pulley oil chamber 22c and further the PRI pulley oil chamber 21c.

In Step S14, the controller 10 performs the hydraulic pressure increase of increasing the SOL pressure Pc2 up to the magnitude of the PRI pressure Ppri increased by the amount of the decrease in the hydraulic pressure. That is, the controller 10 controls the PRI pressure solenoid 42 to adjust the pressure of the PRI pressure Ppri. This is because the PRI pressure Ppri constituted by the PRI-side pressure Pc1 is constituted by the SOL pressure Pc2 by the switching of the switching valve 36. Moreover, this is because the PRI pressure Ppri decreases at this time.

In Step S15, the controller 10 starts to switch the switching valve 36. The switching of the switching valve 36 can be performed when the second idling stop condition is satisfied. The second idling stop condition is satisfied when the preparation of the idling stop is ready as further described below in addition to the first idling stop condition.

In Step S16, the controller 10 determines whether the switching of the switching valve 36 is terminated. Specifically, the controller 10 determines whether the switching of the switching valve 36 is terminated and the present mode is moved to the second mode. The PRI pressure Ppri and the SEC pressure Psec are not originally changed in accordance with the execution of the idling stop. In this regard, however, when the hydraulic pressure increases performed in Step S13 are not released, the PRI pressure Ppri and the SEC pressure Psec become higher than before the first idling stop condition is satisfied when moving to the second mode.

For this reason, more specifically, in determining the transition to the second mode, the controller 10 determines whether the PRI pressure Ppri and the SEC pressure Psec decreased according to the switching of the switching valve 36 become higher than before the first idling stop condition is satisfied. The determination such as this one can be performed based on the outputs of the pressure sensor 53 and the pressure sensor 54, For example. If a negative determination is made in Step S16, the processings return to Step S16. If a positive determination is made in Step S16, the processnigs proceed to Step S17.

In Step S17, the controller 10 releases the hydraulic pressure increases performed in Step S13 and Step S14. After Step S17, the processings of the present flowchart are once terminated.

The controller 10 may release the hydraulic pressure increase after the switching of the switching valve 36 is terminated and before the present mode moves to the second mode. For the sake of this, the controller 10 can release the hydraulic pressure increase as illustrated in a timing chart described hereinafter, for example.

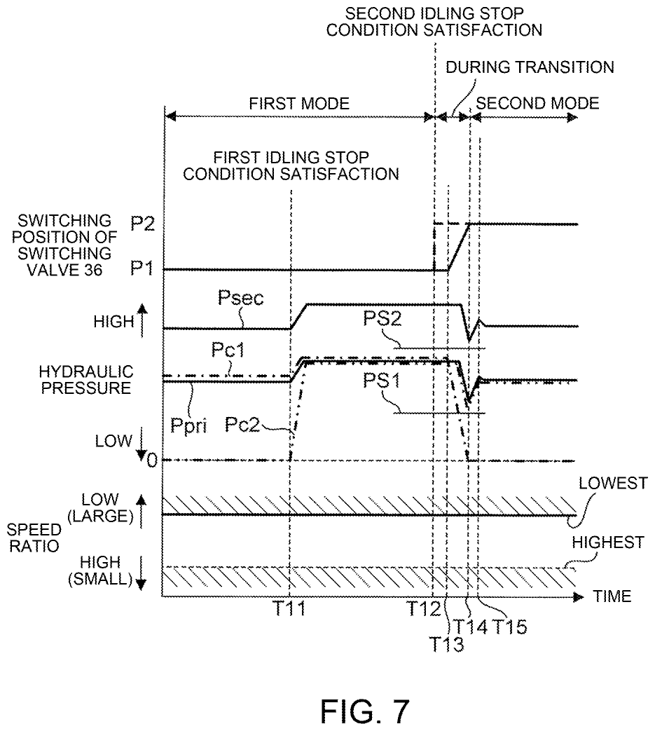

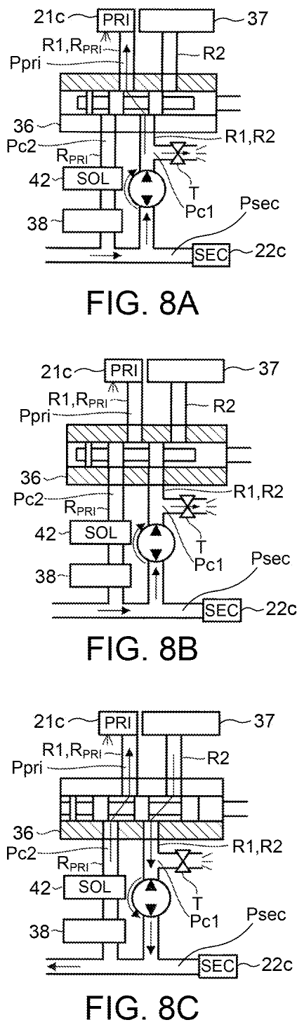

FIG. 7 is a diagram illustrating an example of a timing chart corresponding to the second example. FIGS. 8A, 8B, and 8C are diagrams illustrating the states of the main parts of the hydraulic circuit 3 corresponding to the second example. FIG. 7 illustrates a case where the hydraulic pressure increase is released after the switching of the switching valve 36 is terminated and before the present mode moves to the second mode. The torque capacity guarantee pressure PS2 indicates the torque capacity guarantee pressure PS for the SEC pulley 22.

A mode is the first mode from a time T11 to a time T12. Therefore, during this period, as illustrated in FIG. 8A, the electric oil pump 32 is used for the shift and the PRI pressure Ppri is constituted by the PRI-side pressure Pc1.

The first idling stop condition is satisfied at the time T11. Therefore, the hydraulic pressure increases of the SEC pressure Psec and further the PRI pressure Ppri are performed, and thus the SEC pressure Psec and the PRI pressure Ppri actually start to increase. Moreover, the control of the electric oil pump 32 is switched from the shift control to the hydraulic control. Further, at the time T11, the SOL pressure Pc2 is controlled to the PRI pressure Ppri.

At the time T12, the second idling stop condition is satisfied, and a switching command for the switching valve 36 is issued as indicated by a dashed line. The second idling stop condition is satisfied when the preparation of the idling stop is ready, and the preparation of the idling stop is established when the SEC pressure Psec becomes the indication pressure and the SOL pressure Pc2 becomes the PRI pressure Ppri. Whether the preparation of the idling stop is ready can be determined by, for example, whether a preset predetermined time has elapsed from after the first idling stop condition is satisfied, namely, from the time T11.

At the time T12, as indicated by a dashed line, the switching of the switching valve 36 is started by issuing the switching command for the switching valve 36 to the second position P2. As a result, the present mode moves to a mode during the transition from the first mode. FIG. 8B illustrates a state when the present mode is during the transition.

In accordance with the satisfaction of the second idling stop condition at the time T12, the rotation speed Ne actually starts to decrease at a time T14 at which the present mode moves to the second mode from the mode during the transition. Accordingly, the mechanical oil pump 31 functions as a pump for the source pressure during the transition. During the transition, the rotation direction of the electric oil pump 32 is a forward direction, and the rotation speed of the electric oil pump 32 is instructed to be a constant rotation speed.

During the transition, the decrease in the SEC pressure Psec and further the PRI pressure Ppri occurs as the hydraulic pressure decrease according to the switching of the switching valve 36. This is for the following reason.

Herein, the first oil passage R1 between the electric oil pump 32 and the switching valve 36 starts to communicate with the oil reservoir 37 via the switching valve 36 during the transition. This results in the decrease in the PRI-side pressure Pc1. As a result, the load of the electric oil pump 32 lightens and the rotation speed of the electric oil pump 32 rises. the decrease in the PRI-side pressure Pc1 and the rise in the rotation speed of the electric oil pump 32 such as these occur as a temporary change according to the switching of the switching valve 36.

When the rotation speed of the electric oil pump 32 is raised, the SEC pressure Psec decreases because oil on the SEC pulley oil chamber 22c side is supplied to the oil reservoir 37 side as viewed from the electric oil pump 32. Moreover, during the transition, the PRI pulley oil chamber 21c is communicated with the SEC pulley oil chamber 22c via the PRI pressure solenoid 42 and the pilot valve 38. Therefore, when the SEC pressure Psec decreases, the PRI pressure Ppri also decreases along with this.

That is, as a mechanism for the hydraulic pressure decrease, the decrease in the SEC pressure Psec first occurs and the PRI pressure Ppri also decreases in a manner accompanying this, and therefore the hydraulic pressure increases of the SEC pressure Psec and further the PRI pressure Ppri are performed at the time T11 described above.

At a time T13, the oil passage communicated by the switching valve 36 at the first position P1 is blocked. As a result, the actual position of the switching valve 36 becomes the intermediate position and the PRI-side pressure Pc1 starts to decrease.

At the time T14, the switching valve 36 is switched to the second position P2. As a result, the PRI pressure Ppri is constituted by the SOL pressure Pc2. FIG. 8C illustrates a state when the actual position of the switching valve 36 is the second position P2.

At the time T14, the rotation direction of the electric oil pump 32 is switched to a reverse direction. At the time T14, the PRI-side pressure Pc1 becomes zero in gauge pressure, and the electric oil pump 32 sufficiently functions as a pump for the source pressure. Therefore, the SEC pressure Psec and the PRI pressure Ppri start to increase from the time T14.

In this example, at the time T11, the hydraulic pressure increases of the SEC pressure Psec and further the PRI pressure Ppri are performed by an amount of the decreased hydraulic pressure according to the switching of the switching valve 36, and the SOL pressure Pc2 is also increased up to the PRI pressure Ppri. Therefore, the PRI pressure Ppri starts to increase before falling below the torque capacity guarantee pressure PS1, and the SEC pressure Psec starts to increase before falling below the torque capacity guarantee pressure PS2 at the time T14.

In this example, the release of the hydraulic pressure increases of the PRI pressure Ppri and the SEC pressure Psec is also performed near the time T14. Therefore, the rise in the PRI pressure Ppri and the SEC pressure Psec from the time T14 also includes the influence of the decrease in the PRI pressure Ppri and the SEC pressure Psec according to the release of the hydraulic pressure increases.

At a time T15, both the PRI pressure Ppri and the SEC pressure Psec become higher than before the first idling stop condition is not satisfied. Therefore, the present mode moves to the second mode from the time T15.

The release of the hydraulic pressure increases of the PRI pressure Ppri and the SEC pressure Psec as illustrated in this example can be performed as described below. That is, when the switching valve 36 is switched from the first position P1 to the second position P2, the SEC pressure Psec after switching the switching valve 36 can be estimated based on the current value of the electric oil pump 32. Moreover, according to a difference between the estimated value of the SEC pressure Psec such as this one and the indicated value of the SEC pressure Psec, it is possible to grasp a timing at which the PRI pressure Ppri and the SEC pressure Psec do not fall below the corresponding torque capacity guarantee pressures PS even if the hydraulic pressure increases of the PRI pressure Ppri and the SEC pressure Psec are released.

Therefore, in this case, when the difference between the indicated value and the estimated value of the SEC pressure Psec estimated as described above falls within a predetermined value, the hydraulic pressure increase of the SEC pressure Psec can be released. This predetermined value can be previously set as a value to define a timing at which the PRI pressure Ppri and the SEC pressure Psec do not fall below the corresponding torque capacity guarantee pressures PS even if the hydraulic pressure increase of the SEC pressure Psec is released.

Next, main effects according to the present embodiment will be explained.

The control method for the power transmission device according to the present embodiment is used in the power transmission device that includes the variator 2, the first oil passage R1, the electric oil pump 32, the second oil passage R2, the switching valve 36, and the third oil passage R3 and in which the switching valve 36 switches between two positions of the first position P1 and the second position P2. The control method for the power transmission device includes: performing switching of the switching valve 36 at a time when the idling stop condition is not satisfied or when the first idling stop condition is satisfied, the time corresponding to a time when the predetermined condition is satisfied; and performing the hydraulic pressure increase of increasing the PRI pressure Ppri or the SEC pressure Psec compared to before the predetermined condition is satisfied when switching the switching valve 36.

According to the method thus configured, by increasing the PRI pressure Ppri or the SEC pressure Psec when switching the switching valve 36, these pressures can be prevented from falling below the torque capacity guarantee pressures PS even if the hydraulic pressure decreases in the pulley oil chamber. Therefore, the oil in the oil reservoir 37 can be supplied to the PRI pulley oil chamber 21c via the electric oil pump 32 for shift by the switching of the switching valve 36, and the occurrence of the belt slip in the variator 2 can be also suppressed when switching the switching valve 36.

In the present embodiment, the hydraulic pressure of a pulley oil chamber of which the hydraulic pressure decreases in accordance with the switching of the switching valve 36, among the PRI pulley oil chamber 21c and the SEC pulley oil chamber 22c, is increased by the hydraulic pressure increase by an amount equal to or larger than the amount of the hydraulic pressure decreased in this pulley oil chamber. This makes it possible to prevent the hydraulic pressure of the pulley oil chamber from falling below the torque capacity guarantee pressure PS.

The control method for the power transmission device according to the present embodiment further includes releasing the hydraulic pressure increase after the switching of the switching valve 36 is terminated. According to the method thus configured, the hydraulic pressure of the pulley oil chamber that decreases by the switching of the switching valve 36 can be prevented from falling below the torque capacity guarantee pressure PS.

In the present embodiment, as the switching of the switching valve 36, the switching valve 36 is switched from the second position P2 to the first position P1. Moreover, the hydraulic pressure of the PRI pulley oil chamber 21c is increased as the hydraulic pressure increase. Furthermore, by releasing the hydraulic pressure increase of the PRI pressure Ppri when the PRI pressure Ppri decreased according to the switching of the switching valve 36 becomes higher than before the idling stop condition is not satisfied, the hydraulic pressure increase of the PRI pressure Ppri is released after the switching of the switching valve 36 is terminated. As a result, the hydraulic pressure of the pulley oil chamber can be more surely prevented from falling below the torque capacity guarantee pressure PS.

In the present embodiment, as the switching of the switching valve 36, the switching valve 36 is switched from the first position P1 to the second position P2. Moreover, the hydraulic pressures of the PRI pulley oil chamber 21c and the SEC pulley oil chamber 22c are increased as the hydraulic pressure increase. Furthermore, by releasing the hydraulic pressure increase when the PRI pressure Ppri and the SEC pressure Psec decreased according to the switching of the switching valve 36 become higher than before the first idling stop condition is satisfied, the hydraulic pressure increase is released after the switching of the switching valve 36 is terminated. As a result, the hydraulic pressure of the pulley oil chamber can be more surely prevented from falling below the torque capacity guarantee pressure PS.

In the present embodiment, the PRI pressure solenoid 42 is further provided in the third oil passage R3, and the switching valve 36 is switched from the first position P1 to the second position P2 as the switching of the switching valve 36. In this case, the control method for the power transmission device according to the present embodiment is to control the PRI pressure solenoid 42 to adjust the PRI pressure Ppri when switching the switching valve 36.

According to the method thus configured, even if the electric oil pump 32 is used as a pump for the source pressure when switching the switching valve 36 to the second position P2, the PRI pressure Ppri can be prevented from falling below the torque capacity guarantee pressure PS1 by the decrease in the line pressure PL according to this.

In releasing the hydraulic pressure increase of the SEC pressure Psec, when the switching valve 36 is switched from the second position P2 to the first position P1 as the switching of the switching valve 36, the following can be also performed.

That is, in this case, when the difference between the indicated value of the PRI pressure Ppri and the estimated value of the PRI pressure Ppri estimated based on the current value of the electric oil pump 32 and the actual hydraulic pressure of the SEC pressure Psec falls within the predetermined value, the hydraulic pressure increase of the SEC pressure Psec can be released. This makes it possible to expedite the transition to the first mode compared to a case where the hydraulic pressure increase of the SEC pressure Psec is released when the PRI pressure Ppri becomes higher than before the idling stop condition is not satisfied.

In releasing the hydraulic pressure increase of the SEC pressure Psec, when the switching valve 36 is switched from the first position P1 to the second position P2 as the switching of the switching valve 36, the following can be also performed.

That is, in this case, the hydraulic pressures of the PRI pulley oil chamber 21c and the SEC pulley oil chamber 22c can be increased as the hydraulic pressure increase. Moreover, when the difference between the indicated value of the SEC pressure Psec and the estimated value of the SEC pressure Psec estimated based on the current value of the electric oil pump 32 falls within the predetermined value, the hydraulic pressure increase can be released. This makes it possible to expedite the transition to the second mode compared to the case where the hydraulic pressure increase is released when the PRI pressure Ppri and the SEC pressure Psec become higher than before the first idling stop condition is satisfied.

Next, another modified example of the present embodiment will be explained.

The hydraulic pressure increase may be performed as described below.

That is, when the hydraulic pressure of a pulley oil chamber of which the hydraulic pressure decreases in accordance with the switching of the switching valve 36 among the PRI pulley oil chamber 21c and the SEC pulley oil chamber 22c falls below the torque capacity guarantee pressure PS, the hydraulic pressure increase may be performed to increase the hydraulic pressure of this pulley oil chamber by an amount equal to or larger than the difference between the torque capacity guarantee pressure PS and the hydraulic pressure of this pulley oil chamber when falling below the torque capacity guarantee pressure PS. Specifically, the hydraulic pressure of this pulley oil chamber falls below the torque capacity guarantee pressure PS when the hydraulic pressure increase is not performed. Even in this way, the hydraulic pressure of the pulley oil chamber can be prevented from falling below the torque capacity guarantee pressure PS.

The circumstances that the discharge flow rate becomes smaller than the required flow rate in the mechanical oil pump 31 are related to the switching of the hydraulic source from the mechanical oil pump 31 to the electric oil pump 32 that is performed together with the switching of the switching valve 36.

For this reason, when the switching valve 36 is switched from the first position P1 to the second position P2 as the switching of the switching valve 36, the hydraulic pressure increase may be performed when the rotation speed Nmp is equal to or less than a threshold when switching the switching valve 36. This threshold is the upper limit of the rotation speed Nmp at which the execution of the hydraulic pressure increase of the SEC pressure Psec is permitted, and for example, is the rotation speed Nmp according to the idling rotation speed. Even in this way, the hydraulic pressure increase of the SEC pressure Psec can be performed at an appropriate timing.

In this case, the threshold may be made larger as the oil temperature T_{OIL} is higher. This makes it possible to appropriately perform the hydraulic pressure increase of the SEC pressure Psec in accordance with the oil temperature T_{OIL}.

When the discharge flow rate of the mechanical oil pump 31 is smaller than the required flow rate, the actual pressure of the line pressure PL cannot follow the indication pressure and thus the difference between the actual pressure and the indication pressure of the line pressure PL occurs.

For this reason, when the switching valve 36 is switched from the first position P1 to the second position P2 as the switching of the switching valve 36, the hydraulic pressure increase may be performed when the difference between the actual pressure and the indication pressure of the line pressure PL is larger than the predetermined value when switching the switching valve 36. Even in this way, the hydraulic pressure increase of the SEC pressure Psec can be performed at an appropriate timing.

In releasing the hydraulic pressure increase after the switching of the switching valve 36 is terminated, the hydraulic pressure increase may be released based on the switching position of the switching valve 36. Even in this way, the hydraulic pressure increase can be released at an appropriate timing. Such a modified example is applicable to a case where the switching valve 36 is switched from the first position P1 to the second position P2 as the switching of the switching valve 36, for example.

When the switching valve 36 is switched from the first position P1 to the second position P2 as the switching of the switching valve 36, the modified example of the hydraulic pressure increase and the release of the hydraulic pressure increase can be also applied to the hydraulic pressure increase and the release of the hydraulic pressure increase of the PRI pressure Ppri.

In the present embodiment, the switching of the switching valve 36 is performed at a time when the idling stop condition is satisfied or when the idling stop condition is not satisfied, including the case where the idling stop condition is the first idling stop condition, the time corresponding to a time when the predetermined condition is satisfied. As a result, in using the electric oil pump 32 as a pump for the source pressure in a vehicle in which the idling stop is performed, the switching of the switching valve 36 can be appropriately performed.

As described above, the embodiment of the present invention has been explained, but the above embodiment is only a part of the application example of the present invention and the technical scope of the present invention is not intended to be limited to the specific configurations of the above embodiment.

In the embodiment described above, it has been explained that the idling stop is performed as a driving-source automatic stop control. However, the driving-source automatic stop control may be, for example, a driving-source automatic stop control such as a coast stop and a sailing stop.

The coast stop is executed when a coast stop condition is satisfied. The coast stop condition is a condition including: that the vehicle speed VSP is a low vehicle speed (less than a predetermined vehicle speed); that there is no depression of the accelerator pedal; that there is depression of the brake pedal; and that a forward range is selected in the transmission 1. The predetermined vehicle speed is the vehicle speed VSP at which the lock-up clutch LU is disengaged, for example.

The sailing stop is executed when a sailing stop condition is satisfied. The sailing stop condition includes: that the vehicle speed VSP is a middle or high speed (equal to or larger than the predetermined vehicle speed); that there is no depression of the accelerator pedal; and that there is no depression of the brake pedal. The predetermined vehicle speed may be set to a value different from the predetermined vehicle speed set in the coast stop.

The coast stop condition is satisfied when all conditions included in the coast stop condition are satisfied and is not satisfied when any of the conditions included in the coast stop condition is not satisfied. The same applies to the sailing stop condition.

The driving-source automatic stop control may include a plurality of driving-source automatic stop controls. When having the plurality of driving-source automatic stop controls, it can be determined whether the present mode is the second mode by determining whether any of the plurality of driving-source automatic stop controls is being executed. Moreover, it can be determined whether the mode is switched to the first mode by determining whether the execution condition of the driving-source automatic stop control in the execution is not satisfied.

Furthermore, when having the plurality of driving-source automatic stop controls, it can be determined whether the present mode is the first mode by determining whether all controls of the plurality of driving-source automatic stop controls are being stopped. Moreover, it can be determined whether the mode is switched to the second mode by determining whether the execution condition (preparation condition) of any of the plurality of driving-source automatic stop controls is satisfied.

In the embodiment described above, it has been explained that the control method for the power transmission device is realized by the controller 10. However, the control method for the power transmission device may be realized by a single controller (the transmission controller 11, for example).

This application is based upon and claims the benefit of priority from Japanese Patent Application No. 2017-254764 filed with the Japan Patent Office on Dec. 28, 2017, the entire contents of which are incorporated herein by reference.

1. A control method for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is in a communication state; and
a second position at which the second oil passage and the first oil passage on a secondary pulley oil chamber side are in a communication state and the third oil passage and the first oil passage on a primary pulley oil chamber side are in a communication state, and
the control method comprising:
performing a switching of the switching valve when a predetermined condition is satisfied; and
performing, when switching the switching valve, a hydraulic pressure increase of increasing a hydraulic pressure of the primary pulley oil chamber or the secondary pulley oil chamber compared to before the predetermined condition is satisfied.

2. The control method for the power transmission device according to claim 1, the control method comprising:
increasing a hydraulic pressure of a pulley oil chamber of which the hydraulic pressure decreases in accordance with the switching of the switching valve among the primary pulley oil chamber and the secondary pulley oil chamber by the hydraulic pressure increase by an amount equal to or larger than an amount of the hydraulic pressure decreased in the pulley oil chamber.

3. The control method for the power transmission device according to claim 1, the control method comprising:
increasing, when a hydraulic pressure of a pulley oil chamber of which the hydraulic pressure decreases in accordance with the switching of the switching valve among the primary pulley oil chamber and the secondary pulley oil chamber falls below a torque capacity guarantee pressure of the continuously variable transmission mechanism, the hydraulic pressure of the pulley oil chamber by the hydraulic pressure increase by an amount equal to or larger than a difference between the torque capacity guarantee pressure and the hydraulic pressure of the pulley oil chamber when falling below the torque capacity guarantee pressure.

4. The control method for the power transmission device according to claim 1, the control method comprising:
further providing a mechanical oil pump connected to the first oil passage and driven by power of the driving source;
performing a switching of the switching valve from the first position to the second position as the switching of the switching valve; and
performing, when switching the switching valve, the hydraulic pressure increase when a rotation speed of the mechanical oil pump is equal to or less than a threshold.

5. The control method for the power transmission device according to claim 4, wherein the threshold is made larger as an oil temperature is higher.

6. The control method for the power transmission device according to claim 1, the control method comprising:
Performing a switching of the switching valve from the first position to the second position as the switching of the switching valve; and
performing, when switching the switching valve, the hydraulic pressure increase when a difference between an actual pressure and an indication pressure of a line pressure, the line pressure being a source pressure of oil, is larger than a predetermined value.

7. The control method for the power transmission device according to claim 1, the control method further comprising:
releasing the hydraulic pressure increase after the switching of the switching valve is terminated.

8. The control method for the power transmission device according to claim 7, the control method comprising:
releasing the hydraulic pressure increase based on a switching position of the switching valve to release the hydraulic pressure increase after the switching of the switching valve is terminated.

9. The control method for the power transmission device according to claim 7, the control method comprising:
performing a switching of the switching valve from the second position to the first position as the switching of the switching valve;
increasing a hydraulic pressure of the primary pulley oil chamber as the hydraulic pressure increase; and
releasing the hydraulic pressure increase when the hydraulic pressure of the primary pulley oil chamber decreased according to the switching of the switching valve becomes higher than before the predetermined condition is satisfied to release the hydraulic pressure increase after the switching of the switching valve is terminated.

10. The control method for the power transmission device according to claim 7, the control method comprising:
performing a switching of the switching valve from the second position to the first position as the switching of the switching valve; and
releasing the hydraulic pressure increase, when a difference between a hydraulic-pressure indicated value of the primary pulley oil chamber and a hydraulic-pressure estimated value of the primary pulley oil chamber estimated based on a current value of the electric oil pump and an actual hydraulic pressure of the secondary pulley oil chamber falls within a predetermined value, to release the hydraulic pressure increase after the switching of the switching valve is terminated.

11. The control method for the power transmission device according to claim 7, the control method comprising:
performing a switching of the switching valve from the first position to the second position as the switching of the switching valve;
increasing hydraulic pressures of the primary pulley oil chamber and the secondary pulley oil chamber as the hydraulic pressure increase; and
releasing the hydraulic pressure increase, when each of the hydraulic pressures of the primary pulley oil chamber and the secondary pulley oil chamber decreased according to the switching of the switching valve becomes higher than before the predetermined condition is satisfied, to release the hydraulic pressure increase after the switching of the switching valve is terminated.

12. The control method for the power transmission device according to claim 7, the control method comprising:
performing a switching of the switching valve from the first position to the second position as the switching of the switching valve;
increasing hydraulic pressures of the primary pulley oil chamber and the secondary pulley oil chamber as the hydraulic pressure increase; and
releasing the hydraulic pressure increase, when a difference between a hydraulic-pressure indicated value of the secondary pulley oil chamber and a hydraulic-pressure estimated value of the secondary pulley oil chamber estimated based on a current value of the electric oil pump falls within a predetermined value, to release the hydraulic pressure increase after the switching of the switching valve is terminated.

13. The control method for the power transmission device according to claim 1, the control method comprising:
further providing a pressure control valve configured to adjust a pressure of oil supplied to the primary pulley oil chamber in the third oil passage;
performing a switching of the switching valve from the first position to the second position as the switching of the switching valve; and
controlling the pressure control valve to adjust a hydraulic pressure of the primary pulley oil chamber when switching the switching valve.

14. The control method for the power transmission device according to claim 1, the control method comprising:
performing the switching of the switching valve at a time when an execution condition of automatic stop control for the driving source is satisfied or when the execution condition is not satisfied, including a case where the execution condition is a preparation condition, the time corresponding to a time when the predetermined condition is satisfied.

15. A control device for a power transmission device,
the power transmission device including:
a continuously variable transmission mechanism configured to perform power transmission between a driving source and driving wheels;
a first oil passage communicating between a primary pulley oil chamber and a secondary pulley oil chamber of the continuously variable transmission mechanism;
an electric oil pump provided in the first oil passage;
a second oil passage branching off from the first oil passage between the electric oil pump and the primary pulley oil chamber and communicating with an oil reservoir;
a switching valve provided at a branch point of the first oil passage and the second oil passage; and
a third oil passage branching off from the first oil passage between the electric oil pump and the secondary pulley oil chamber and reaching the switching valve,
the switching valve being configured to switch between two positions of:
a first position at which at least the first oil passage is in a communication state; and
a second position at which the second oil passage and the first oil passage on a secondary pulley oil chamber side are in a communication state and the third oil passage and the first oil passage on a primary pulley oil chamber side are in a communication state, and
the control device comprising a controller configured to:
perform a switching of the switching valve when a predetermined condition is satisfied; and
perform, when switching the switching valve, a hydraulic pressure increase of increasing a hydraulic pressure of the primary pulley oil chamber or the secondary pulley oil chamber compared to before the predetermined condition is satisfied.
